(19) United States
(12) Patent Application Publication
(10) Pub. No.: US 2012/0162671 A1
(43) Pub. Date: Jun. 28, 2012

(54) TAPE PRINTER AND PRINTING CONTROL METHOD OF TAPE PRINTER

(75) Inventor: Takeshi Hosokawa, Shiojiri-shi (JP)

(73) Assignee: Seiko Epson Corporation, Tokyo (JP)

(21) Appl. No.: 13/332,616

(22) Filed: Dec. 21, 2011

(30) Foreign Application Priority Data
Dec. 28, 2010 (JP) 2010-292102

(51) Int. Cl. G06K 15/02

(52) U.S. Cl. 358/1.6

(57) ABSTRACT

A tape printer includes: a printing head which performs a cut mark printing process for printing a cut mark on a tape-shaped medium to indicate a cut position for manual cutting, and a normal printing process for printing a normal printing image on the tape-shaped medium as a printing image other than the cut mark; and a printing process control unit which controls the printing head, wherein the printing process control unit decreases the printing strength of the cut mark during the cut mark printing process to a level lower than the printing strength of the normal printing image such that the adherence strength of the cut mark to the tape-shaped medium becomes smaller than the adherence strength of the normal printing image to the tape-shaped medium.

### CROSS-REFERENCE

The present application claims priority from Japanese Patent Application No. 2010-292102 filed on Dec. 28, 2010, which is hereby incorporated by reference in its entirety.

### BACKGROUND

A tape printer which performs printing on a tape-shape medium (printing tape) to produce a desired label is known. This type of tape printer prints a cut mark indicating a cut position of the tape at a point between labels or at the head (front end) of a label when a plurality of labels are successively produced or when a label whose tape margin length designated beforehand (margin distance) is smaller than the distance between the printing position and the tape cut position (distance between the printing head and the tape cutter of the tape printer) is produced (for example, see Japanese Patent Publication No. 2001-001600 and No. 2002-113914). A user of the tape printer cuts the tape at the cut mark position thus printed by using scissors or a cutter to produce a label.

However, when the user cuts the tape at the cut mark by using scissors or a cutter to produce a label, a part of the cut mark remains at the front end or rear end of the label, and deteriorates the appearance of the produced label.

### SUMMARY

Various embodiments may provide a tape printer and a printing control method of a tape printer capable of producing a label having a preferable appearance from a tape even when the tape is cut at a cut mark position.

According to at least one embodiment of the disclosure, there is provided a tape printer including: a printing head which performs a cut mark printing process for printing a cut mark on a tape-shaped medium to indicate a cut position for manual cutting, and a normal printing process for printing a normal printing image on the tape-shaped medium as a printing image other than the cut mark; and a printing process control unit which controls the printing head. The printing process control unit decreases the printing strength of the cut mark during the cut mark printing process to a level lower than the printing strength of the normal printing image such that the adherence strength of the cut mark to the tape-shaped medium becomes smaller than the adherence strength of the normal printing image to the tape-shaped medium.

According to at least one embodiment of the disclosure, there is provided a printing control method of a tape printer including: performing a cut mark printing process for printing a cut mark on a tape-shaped medium to indicate a cut position for manual cutting, and a normal printing process for printing a normal printing image on the tape-shaped medium as a printing image other than the cut mark by using a printing head. The printing strength of the cut mark is decreased during the cut mark printing process to a level lower than the printing strength of the normal printing image such that the adherence strength of the cut mark to the tape-shaped medium becomes smaller than the adherence strength of the normal printing image to the tape-shaped medium.

According to these structure and method, the printing strength of the cut mark decreases to a level lower than the printing strength of the normal printing image (normal printing image), whereby the adherence strength of the cut mark portion (adherence strength of ink) to the tape (tape-shaped medium) becomes smaller. In this case, the abrasion resistance (friction resistance) and the removal resistance of the cut mark portion become lower. Accordingly, the cut mark printed on the tape can be removed by the method of rubbing off the cut mark portion. More specifically, when producing a label by cutting the tape at the cut mark position using scissors, a cutter or the like, a user can remove a part of the cut mark remaining on the label by eliminating (rubbing) the cut mark. Thus, the user can produce a label having a preferable appearance.

Moreover, when the printing strength of the cut mark is smaller than the printing strength of the normal printing image, the cut mark portion disappears with an elapse of time (disappears more rapidly than the normal printing image). Thus, the appearance of the produced label improves.

It is preferable that the printing process control unit of the tape printer according to above embodiment reduces the energization time of the printing head at the time of execution of the cut mark printing process to a time shorter than the energization time of the printing head at the time of execution of the normal printing process.

According to this structure, the energization time of the printing head at the time of printing of the cut mark is shorter than the energization time of the printing head at the time of normal printing. In this case, the printing strength of the cut mark becomes smaller, whereby the adherence strength of the cut mark portion to the tape decreases. Thus, the abrasion resistance (friction resistance) and the removal resistance of the cut mark portion become lower. Moreover, power consumption required for printing the cut mark can be reduced compared to that in the case of the tape printer in the related art, which contributes to energy saving. Particularly, when a large number of the cut marks are printed between labels for successive production of a large quantity of labels, for example, the reduction of power consumption required for the printing is extremely advantageous.

It is preferable that the printing process control unit of the tape printer according to the above embodiment reduces the voltage applied to the printing head at the time of execution of the cut mark printing process to a voltage lower than the voltage applied to the printing head at the time of execution of the normal printing process.

According to this structure, the voltage applied to the printing head at the time of printing of the cut mark is lower than the voltage applied to the printing head at the time of normal printing. In this case, the printing strength of the cut mark becomes smaller, whereby the adherence strength of the cut mark portion to the tape decreases. Thus, the abrasion resistance (friction resistance) and the removal resistance of the cut mark portion become lower. Moreover, power consumption required for printing the cut mark can be reduced compared to that in the case of the tape printer in the related art, which contributes to energy saving.

It is preferable that the printing process control unit of the tape printer according to the above embodiment reduces the tightness of the contact between the printing head and the tape-shaped medium at the time of execution of the cut mark printing process to a level lower than the tightness of the contact between the printing head and the tape-shaped medium at the time of execution of the normal printing process.

According to this structure, the tightness of the contact between the printing head and the tape-shaped medium at the time of printing of the cut mark is lower than the corresponding tightness of the contact at the time of normal printing. In this case, the printing strength of the cut mark becomes smaller, whereby the adherence strength of the cut mark portion to the tape decreases. Thus, the abrasion resistance (friction resistance) and the removal resistance of the cut mark portion become lower.

### BRIEF DESCRIPTION OF THE DRAWINGS

The invention will be described with reference to the accompanying drawings, wherein like reference numbers reference like elements.

FIG. 1 is a perspective view illustrating the external appearance of a tape printer according to an embodiment of the invention with a cover of the tape printer opened.

FIG. 2 is a control block diagram of the tape printer.

FIG. 3 is a flowchart showing procedures for printing a cut mark CM at a position between labels or at the front end a label.

FIG. 4A illustrates a condition of a label after printing and prior to cutting.

FIG. 4B illustrates the label cut at the positions of cut marks.

FIG. 4C illustrates the label from which the cut marks are removed.

### DESCRIPTION OF EXEMPLARY EMBODIMENT

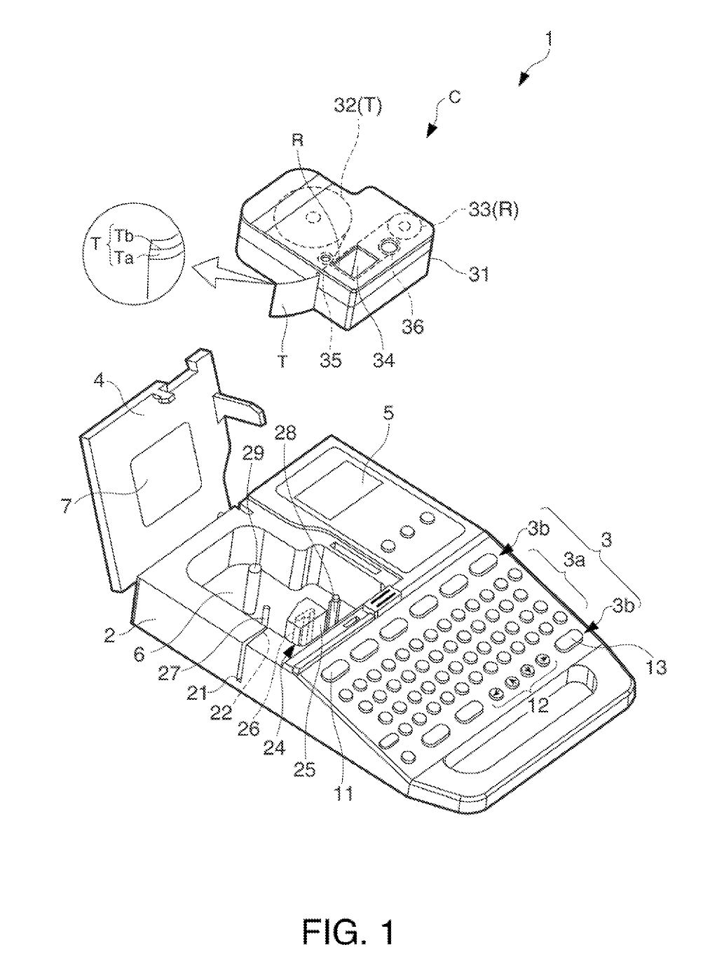

A tape printer according to an embodiment of the invention is hereinafter described with reference to the accompanying drawings. FIG. 1 is a perspective view illustrating the external appearance of a tape printer 1 in this embodiment with an opening and closing cover 4 of the tape printer 1 opened. As illustrated in FIG. 1, the external case of the tape printer 1 is constituted by a device case 2. A keyboard 3 provided with various types of input keys is disposed on the upper front surface of the external case 2. The opening and closing cover 4 is equipped on the left part of the upper rear surface of the tape printer 1. A display screen 5 is provided on the right side of the opening and closing cover 4. A cartridge attachment portion 6 to which a tape cartridge C is attached is concaved inside the opening and closing cover 4. The tape cartridge C is detachably attached to the cartridge attachment portion 6 under the opened condition of the opening and closing cover 4. A check window 7 is provided on the opening and closing cover 4, through which window 7 the attachment or detachment of the tape cartridge C can be checked under the closed condition of the opening and closing cover 4.

The keyboard 3 has arrangements of a character key group 3a, and a function key group 3b through which various operation modes and the like are selected. The character key group 3a has full-key structure conforming to JIS (Japanese Industrial Normals) and includes keys similar to those of a typical word processor such as a shift key provided to reduce the number of keys to be operated. The function key group 3b includes a “print” key 11, cursor keys 12, a “select” key 13, and other keys. Key operation may be inputted through dedicated keys provided for each input in a manner similar to the operation of a typical keyboard, or by using a smaller number of keys used in combination with the shift key or the like.

The “print” key 11 is a key through which a printing command is inputted. The cursor keys 12 are constituted by up, down, left, and right keys (“⇑”, “↓”, “←”, “→”) used for cursor-shift and scrolling. The “select” key 13 is a key operated for selection from choices and for decision.

The display screen 5 is constituted by a liquid crystal display. The display screen 5 is used when a user creates or edits printing data such as text data and image data after inputting a desired text, image or the like (normal printing image) through the keyboard 3, or when the user visually recognizes (checks) the results of the printing data and the like.

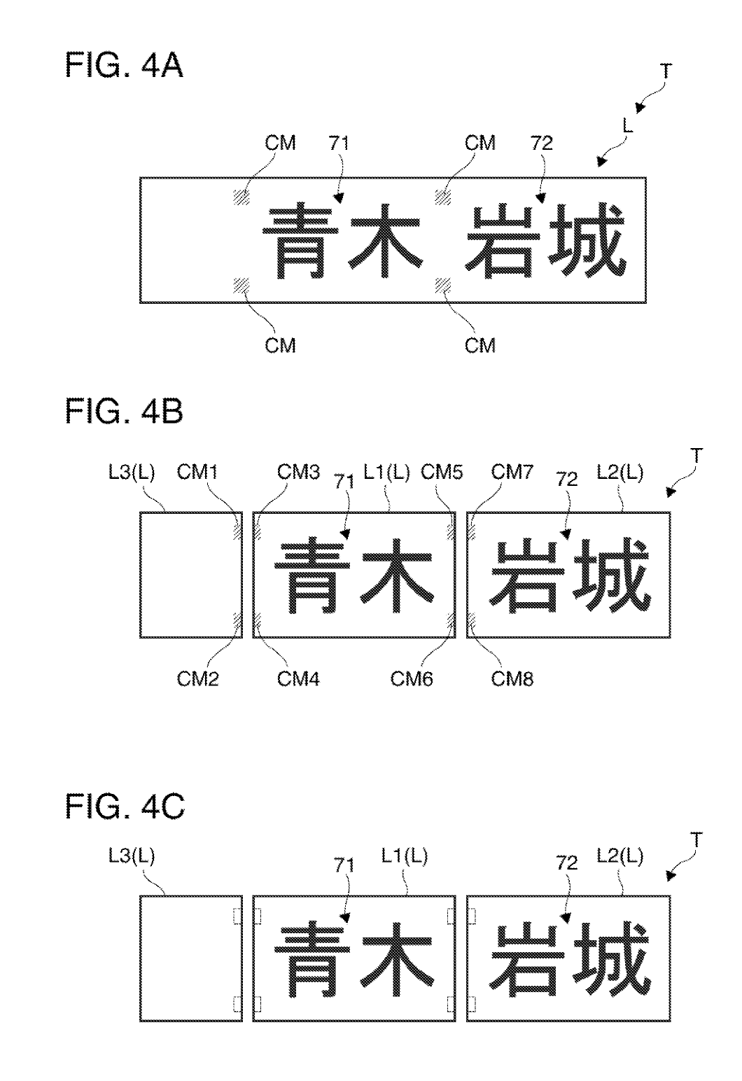

A tape outlet port 21 is provided on the left side of the device case 2 as a communication port between the cartridge attachment portion 6 and the outside. A tape cutter 22 faces to the tape outlet port 21 to cut a delivered printing tape T. The printing tape T after printing is discharged by a predetermined length from the tape outlet port 21, and cut by the tape cutter 22 with temporary stop of the delivery of the printing tape, so as to be formed into a strip-shaped label L (see FIGS. 4A through 4C).

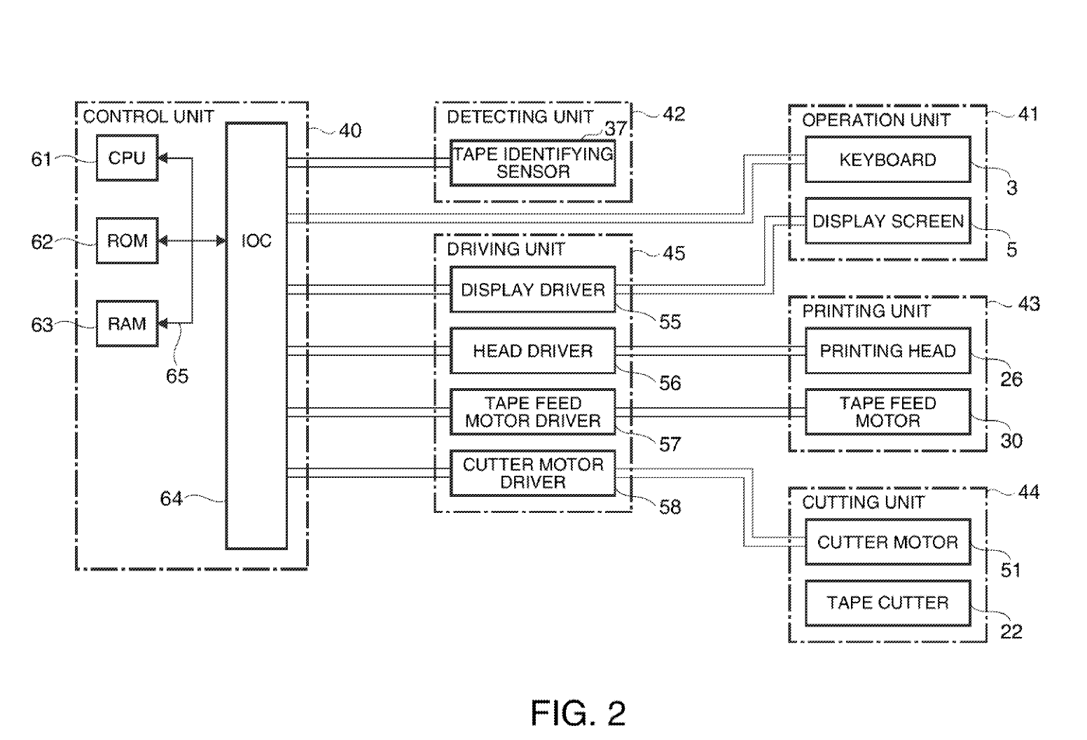

The cartridge attachment portion 6 is provided with a head unit 24 which accommodates a thermal-type printing head 26 within a head cover 25, a platen drive shaft 27 disposed to be opposed to the printing head 26, a winding drive shaft 28 around which an ink ribbon R (described later) is wound, and a positioning projection 29 for positioning a tape reel 32 (described later). A tape feed motor 30 (see FIG. 2) which rotates the platen drive shaft 27 and the winding drive shaft 28 is accommodated below the cartridge attachment portion 6.

The tape cartridge C contains the tape reel 32 disposed at the upper center of the interior of a cartridge case 31 as a reel around which the printing tape T having a fixed width (in the range from about 4 mm to about 48 mm) is wound, and a ribbon reel 33 disposed at a right lower position of the cartridge case 31 as a reel around which the ink ribbon R is wound. The printing tape T and the ink ribbon R have the same width. A through hole 34 through which the head unit 24 is inserted is formed on the left lower side of the tape reel 32. A platen roller 35 rotatable by engagement with the platen drive shaft 27 is disposed to be opposed to the printing head 26 accommodated within the head unit 24 with the overlapping portions of the printing tape T and the ink ribbon R interposed between the platen roller 35 and the printing head 26 after insertion of the head unit 24 into the through hole 34. A ribbon winding reel 36 disposed in the vicinity of the ribbon reel 33 is provided as a component around which the ink ribbon R drawn from the ribbon reel 33 and guided in such a direction as to circulate around the head cover 25 is wound.

With attachment of the tape cartridge C to the cartridge attachment portion 6, which achieves respective insertions of the head cover 25 into the through hole 34, the positioning projection 29 into the center hole of the tape reel 32, and the winding drive shaft 28 into the center hole of the ribbon winding reel 36, the printing head 26 comes into contact with the platen roller 35 with the printing tape T and the ink ribbon R sandwiched therebetween to be brought to the printing condition. Then, the user inputs a desired text or image through the keyboard 3 while checking the edition result shown on the display screen 5, and issues a printing command. In response to this command, the tape printer 1 draws the printing tape T out of the tape cartridge C by the drive of the tape feed motor 30, and performs the desired printing on the printing tape T while selectively heating the heating elements provided on the printing head 26. The printed portion of the printing tape T is discharged through the tape outlet port 21 to the outside. After completion of printing, the tape feed motor 30 delivers the printing tape T by the amount of the tape length including a margin, and stops delivery (the process proceeds to a cutting step).

The printing tape T is constituted by a recording tape Ta having an adhesive layer on the rear surface thereof, and a release tape Tb affixed to the recording tape Ta via the adhesive layer of the recording tape Ta. The printing tape T is wound in a roll shape with the recording tape Ta disposed outside and the release tape Tb disposed inside, and stored within the cartridge case 31. Plural types of printing tapes having different appearances (such as tape width, tape base color, base pattern, and material (feel of material)) are prepared as the printing tape T, one of which types of the printing tape T and the ink ribbon Rare stored in the cartridge case 31. A plurality of holes (not shown) are formed in the rear surface of the cartridge case 31 for identification of the type of the tape cartridge C. In correspondence with the plural holes of the cartridge case 31, a plurality of tape identifying sensors (such as micro-switches) 37 (see FIG. 2) are provided on the cartridge attachment portion 6 so as to detect these holes. The tape identifying sensors 37 can determine the tape type of the tape cartridge C by detecting the condition of the plural holes.

The control structure of the tape printer 1 is now explained with reference to a control block diagram of FIG. 2. The tape printer 1 includes an operation unit 41, a detecting unit 42, a printing unit 43, a cutting unit 44, a driving unit 45, and a control unit 40 (printing control unit) connecting with these units 41 through 45 and controlling the overall operation of the tape printer 1.

The operation unit 41 functions as a user interface for input, edition, and setting of information received from the character key group 3a and the function key group 3b provided on the keyboard 3, display of the respective types of information on the display screen 5, and for other purposes.

The detecting unit 42 has the tape identifying sensors 37 and detects the type of the printing tape T (tape cartridge C). The printing unit 43 has the printing head 26 (thermal head) and the tape feed motor 30, and performs printing on the printing tape T based on the created printing data while delivering the printing tape T and the ink ribbon R.

The cutting unit 44 has the tape cutter 22 and a cutter motor 51 for driving the tape cutter 22. The cutting unit 44 cuts the printed portion of the printing tape T after a printing process performed by the printing unit 43 into the label L having a predetermined length. The driving unit 45 has a display driver 55, a head driver 56, a tape feed motor driver 57, and a cutter motor driver 58 to drive the corresponding units.

The control unit 40 includes a CPU (central processing unit) 61, a ROM (read only memory) 62, a RAM (random access memory) 63, and an input/output control device (hereinafter referred to as “IOC (input output controller)”) 64. These units 61 through 64 are connected with each other via an internal bus 65. The RAM 63 is a work area used by the CPU 61 for execution of the respective processes. The ROM 62 stores control programs and control data used for various controls performed by the CPU 61.

The control programs stored in the ROM 62 include a printing control program which changes the printing strength of the printing performed by the tape printer 1 between a strength for a printing process (cut mark printing process) executed for printing a cut mark CM (see FIGS. 4A through 4C) on the printing tape T and a strength for a printing process (normal printing process) executed for printing a printing image other than the cut mark CM (normal printing image such as text and image inputted by the user). More specifically, the printing control program sets the printing strength for the cut mark CM at a lower strength than the printing strength for the printing image other than the cut mark CM (establishes the relation “printing strength for cut mark CM”<“printing strength for printing image other than cut mark CM”).

The cut mark CM is printed at a position between the labels L or at the front end (head) of the label L in a shape extending in the width direction of the label L to indicate a cut position at which the printing tape T is manually cut when a plurality of the labels L are successively produced or when the label L whose margin length designated by the user is smaller than the distance between the printing head 26 and the tape cutter 22 is produced. The user manually cuts the printing tape T at the position indicated by the cut mark CM by using scissors, a cutter or the like to produce the desired label L.

According to this structure, the CPU 61 receives various signals and data from the respective units within the tape printer 1 via the IOC 64 under the respective control programs stored in the ROM 62. Besides, the CPU 61 processes the respective data within the RAM 63 based on the respective inputted signals and data, and outputs various signals and data produced based on the processed data to the respective units of the tape printer 1 via the IOC 64 to perform various process controls.

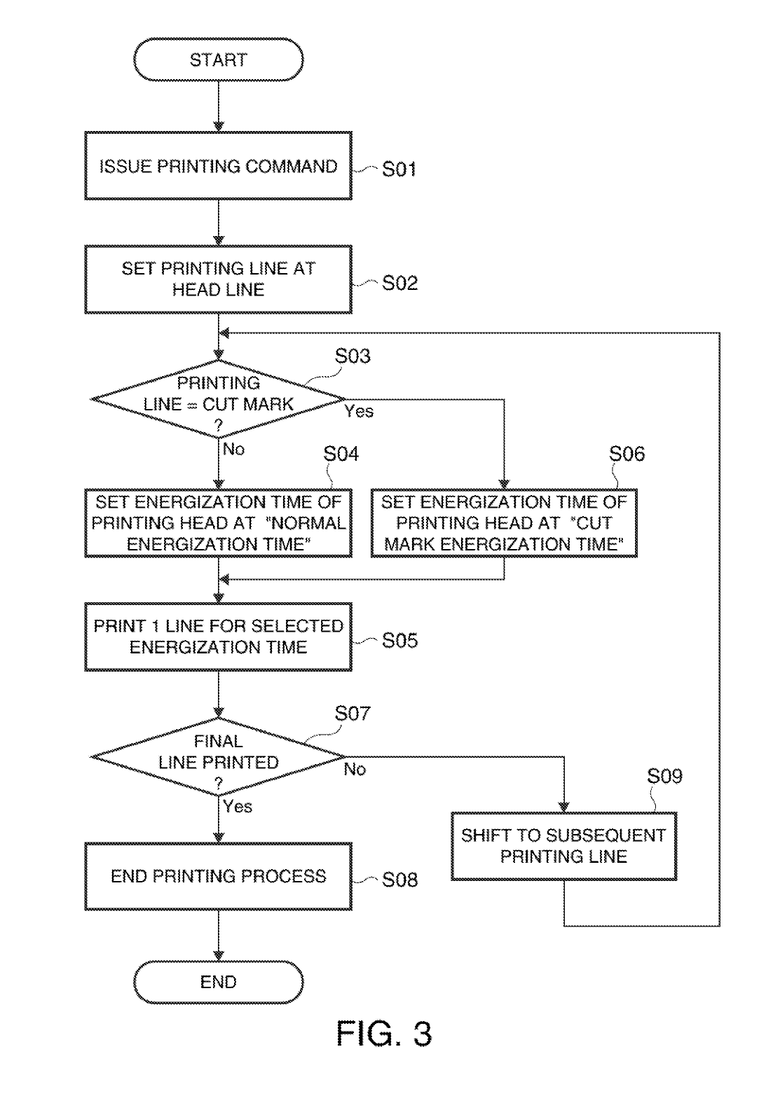

The printing process procedures (printing control method) executed for printing the cut mark CM at a position between the labels L or at the front end (head) of the label L by using the tape printer 1 according to this embodiment of the invention is now explained with reference to a flowchart of FIG. 3. In the process of printing, the tape printer 1 in this embodiment sets a shorter time (hereinafter referred to as “cut mark energization time”) for energizing the printing head 26 during printing of the cut mark CM than the time (hereinafter referred to as “normal energization time”) for energizing the printing head 26 during printing of a text so as to set the printing strength of the cut mark CM at a strength smaller than the printing strength of a printing image (herein referred to as “text” for convenience of explanation) other than the cut mark CM. In other words, printing is performed in such a condition that the relation “normal energization time”>“cut mark energization time” holds.

The “normal energization time” is a time for energization sufficient for retaining a printing strength (adherence strength) to such a level as to avoid removal of the printed portion by friction or the like in the process of printing by using the tape printer 1. On the other hand, the “cut mark energization time” is a time for energization sufficient for producing a printing strength (adherence strength) to such a level as to allow removal of the printed portion by friction or the like. For example, the “cut mark energization time” is set at the half of the “normal energization time”.

When the user inputs a printing target text and issues a printing command by pressing the “print” key 11 (S01), the tape printer 1 (control unit 40) sets a printing target line at the head line of the printing target text (printing data based on the text) (S02). Then, the tape printer 1 determines whether the printing target line is the cut mark CM or not (S03). When the printing line is not the cut mark CM (S03; No), the tape printer 1 sets the energization time of the printing head 26 (thermal head) at the “normal energization time” (S04), and prints one line for the selected energization time (S05; normal printing).

When the printing line is the cut mark CM (S03; Yes), the tape printer 1 sets the energization time of the printing head 26 at the “cut mark energization time” (S06), and prints the one line (cut mark CM) for the selected energization time (S05; cut mark printing). In other words, when the printing target line is the cut mark CM, the line is printed for a shorter energization time than the energization time of the printing head 26 at the time of normal text printing.

Then, the tape printer 1 determines whether the printing line printed in step S05 is the final line of the printing target text (printing data based on the text) (S07). When the printing line printed in step S05 is the final line (S07; Yes), the tape printer 1 ends a series of processes for printing (S08). When the printing line printed in step S05 is not the final line (S07; No), the tape printer 1 shifts the printing line to the subsequent line (S09) and repeats the processes after step S03 (processes from S03 to S07) until the printing line reaches the final line.

An example of the label L produced by the procedures shown in the flowchart of FIG. 3 is now explained with reference to FIGS. 4A through 4C. FIG. 4A illustrates the condition of the label L after printing by the tape printer 1 and prior to cutting. This figure shows the one label L outputted after printing of the cut mark CM for each of positions at the front end of a label image 71, and positions between the label image 71 and a label image 72 (four cut marks CM in total in the figure) at the time of successive printing of the label image 71 and the label image 72 inputted by the user. These cut marks CM are represented by hatched portions which indicate that the printing strength (adherence strength) of the cut marks CM is smaller than that of the black characters (label image 71 and label image 72) due to the shorter energization time of the printing head 26 than the corresponding time for printing the black characters.

FIG. 4B illustrates the label L (labels L1 through L3) produced when the user cuts the printing tape T (by manual cutting) at the positions of the cut marks CM shown in FIG. 4A. As can be seen from this figure, a part of the cut mark CM (cut mark pieces CM1 through CM8) remains on each of both sides of the respective cutting positions, more specifically, the front end and rear end of the label L1, the front end of the label L2, and the rear end of the label L3 when the user cuts the printing tape T at the positions of the cut marks CM (along the cut marks CM) by using scissors, a cutter or the like.

However, the user can remove the cut mark pieces CM1 through CM8 printed on the labels L1 through L3 by rubbing off the cut marks CM1 through CM8, and obtain the label L (labels L1 through L3) from which the cut mark pieces CM1 through CM8 are removed as illustrated in FIG. 4C (dotted lines in FIG. 4C show that the cut mark pieces CM1 through CM8 shown in FIG. 4B are removed). The part designated by the label L3 illustrated in FIGS. 4B and 4C corresponds to an unnecessary portion (unnecessary range) after the label L1 is produced, and thus is not practically used as the label L.

According to this embodiment, the energization time of the printing head 26 at the time of printing of the cut mark CM is shorter than the energization time of the printing head 26 at the time of printing of the normal printing image (normal printing image). Thus, the printing strength of the cut mark CM portion decreases, whereby the adherence strength of the cut mark CM portion (adherence strength of ink) to the printing tape T becomes smaller. In other words, the abrasion resistance (friction resistance) and the removal resistance of the cut mark CM portion become lower. Accordingly, the cut mark CM printed on the printing tape T can be removed by the method of rubbing off the cut mark CM portion.

More specifically, when producing the label L (label L1 and label L2) by cutting the printing tape T along the cut marks CM as illustrated in FIG. 4B, the user can remove the parts of the cut marks CM (cut mark pieces CM3 through CM8) which remain on the label L (label L1 and label L2) (by rubbing). Thus, the user can produce the label L (label L1 and label L2) having a preferable appearance as illustrated in FIG. 4C.

Moreover, the shortened energization time for the printing head 26 more reduces power consumption required for printing the cut mark CM than in the case of the tape printer in the related art, which contributes to energy saving. Particularly, when a large number of the cut marks CM are printed between the labels L for successive production of a large quantity of the labels L, for example, the reduction of power consumption required for the printing is extremely advantageous.

According to this embodiment, the printing strength of the cut mark CM is lowered by reduction of the energization time of the printing head 26. However, the printing strength of the cut mark CM may be decreased by reduction of the voltage applied to the printing head 26 at the time of printing of the cut mark CM to a voltage lower than the voltage applied to the printing head 26 at the time of printing of the printing image other than the cut mark CM. Alternatively, the printing strength of the cut mark CM may be decreased by reduction of the tightness of the contact between the printing head 26 and the printing tape T at the time of printing of the cut mark CM to a degree lower than the tightness of the corresponding contact at the time of normal printing.

While the cut marks CM are represented by dots (hatched portions) in FIGS. 4A and 4B, the cut marks CM may be printed as lines and dotted lines extending in the width direction of the printing tape T, for example.

The invention is not limited to the embodiment described herein. Various modifications and changes including other device structures, different processing steps and the like associated with the tape printer 1 may be made without departing from the scope of the invention.

What is claimed is:

1. A tape printer comprising:
a printing head configured to perform a cut mark printing process for printing a cut mark on a tape-shaped medium to indicate a cut position for manual cutting, and a normal printing process for printing a normal printing image on the tape-shaped medium as a printing image other than the cut mark; and
a printing process control unit configured to control the printing head,
wherein
the printing process control unit decreases the printing strength of the cut mark during the cut mark printing process to a level lower than the printing strength of the normal printing image such that the adherence strength of the cut mark to the tape-shaped medium becomes smaller than the adherence strength of the normal printing image to the tape-shaped medium.

2. The tape printer according to claim 1, wherein the printing process control unit reduces the energization time of the printing head at the time of execution of the cut mark printing process to a time shorter than the energization time of the printing head at the time of execution of the normal printing process.

3. The tape printer according to claim 1, wherein the printing process control unit reduces the voltage applied to the printing head at the time of execution of the cut mark printing process to a voltage lower than the voltage applied to the printing head at the time of execution of the normal printing process.

4. The tape printer according to claim 1, wherein the printing process control unit reduces the tightness of the contact between the printing head and the tape-shaped medium at the time of execution of the cut mark printing process to a level lower than the tightness of the contact between the printing head and the tape-shaped medium at the time of execution of the normal printing process.

5. A printing control method of a tape printer, comprising:
performing a cut mark printing process for printing a cut mark on a tape-shaped medium to indicate a cut position for manual cutting, and a normal printing process for printing a normal printing image on the tape-shaped medium as a printing image other than the cut mark by using a printing head,
wherein
the printing strength of the cut mark is decreased during the cut mark printing process to a level lower than the printing strength of the normal printing image such that the adherence strength of the cut mark to the tape-shaped medium becomes smaller than the adherence strength of the normal printing image to the tape-shaped medium.

6. The printing control method according to claim 5, wherein the performing the cut mark printing process step reduces the energization time of the printing head at the time of execution of the cut mark printing process to a time shorter than the energization time of the printing head at the time of execution of the normal printing process.

7. The printing control method according to claim 5, wherein the performing the cut mark printing process step reduces the voltage applied to the printing head at the time of execution of the cut mark printing process to a voltage lower than the voltage applied to the printing head at the time of execution of the normal printing process.

8. The printing control method according to claim 5, wherein the performing the cut mark printing process step reduces the tightness of the contact between the printing head and the tape-shaped medium at the time of execution of the cut mark printing process to a level lower than the tightness of the contact between the printing head and the tape-shaped medium at the time of execution of the normal printing process.
